(19) United States
(12) Patent Application Publication
(10) Pub. No.: US 2017/0106544 A1
(43) Pub. Date: Apr. 20, 2017

(54) KNIFE

(71) Applicant: MILWAUKEE ELECTRIC TOOL CORPORATION, Brookfield, WI (US)

(72) Inventor: Christopher S. Hoppe, Milwaukee, WI (US)

(21) Appl. No.: 15/293,355

(22) Filed: Oct. 14, 2016

Related U.S. Application Data
(60) Provisional application No. 62/241,956, filed on Oct. 15, 2015.

(51) Int. Cl. B26B 1/04

(52) U.S. Cl. CPC B26B 1/044

(57) ABSTRACT

A folding knife including a handle, a blade having a cutting edge, and the blade is pivotably coupled to the handle about a pivot axis between a retracted position and an extended position. The blade is received within the handle in the retracted position and the cutting edge is exposed in the extended position. The folding knife further includes a liner between the handle and the blade. The liner has a resilient member that biases the blade toward the retracted position when the blade is in the retracted position and the resilient member biases the blade toward the extended position when the blade pivots in a direction from the retracted position toward the extended position.

### CROSS-REFERENCE TO RELATED APPLICATIONS

This application claims priority to co-pending, prior-filed U.S. Provisional Patent Application No. 62/241,956, filed Oct. 15, 2015, the entire contents of which are hereby incorporated by reference.

### BACKGROUND

The present invention relates to knives and more particularly to folding knives.

### SUMMARY

In one embodiment, the invention provides a folding knife including a handle, a blade having a cutting edge, and the blade is pivotably coupled to the handle about a pivot axis between a retracted position and an extended position. The blade is received within the handle in the retracted position and the cutting edge is exposed in the extended position. The folding knife further includes a liner between the handle and the blade. The liner has a resilient member that biases the blade toward the retracted position when the blade is in the retracted position and the resilient member biases the blade toward the extended position when the blade pivots in a direction from the retracted position toward the extended position.

In another embodiment, the invention provides a folding knife including a first handle portion, a second handle portion, and a blade having a cutting edge. The blade is pivotably coupled to the first handle portion and the second handle portion about a pivot axis. The folding knife further includes a first liner between the first handle portion and the blade. The first liner is a unibody component and has a resilient member to bias the blade toward a retracted position and an extended position. The cutting edge is disposed between the first and second handle portions in the retracted position and the cutting edge is exposed in the extended position. The folding knife further includes a second liner between the second handle portion and the blade. The second liner is a unibody component and has a locking arm to maintain the blade in the extended position.

Other aspects of the invention will become apparent by consideration of the detailed description and accompanying drawings.

### BRIEF DESCRIPTION OF THE DRAWINGS

FIG. 1 is a perspective view of a knife according to an embodiment of the invention.

FIG. 2 is an exploded perspective view of the knife of FIG. 1.

FIG. 3 is a side view of the knife of FIG. 1, illustrating a partial cross-section through a handle of the knife, and illustrating a cutting blade of the knife in a first position.

FIG. 4 is a side view of the knife, illustrating a partial cross-section through the handle of the knife, and illustrating the cutting blade of the knife in a second position.

FIG. 5 is a side view of the knife, illustrating a partial cross-section through the handle of the knife, and illustrating the cutting blade of the knife in a third position.

FIG. 6 is a side view of a knife according to another embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

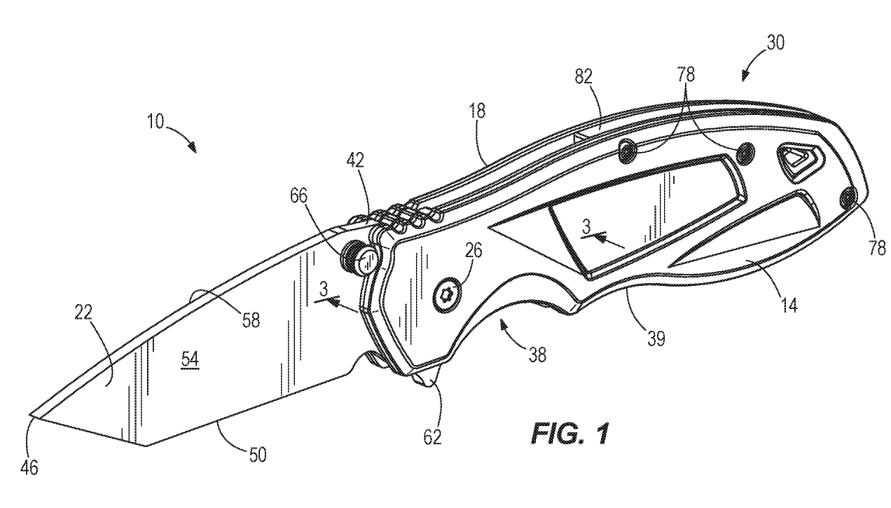

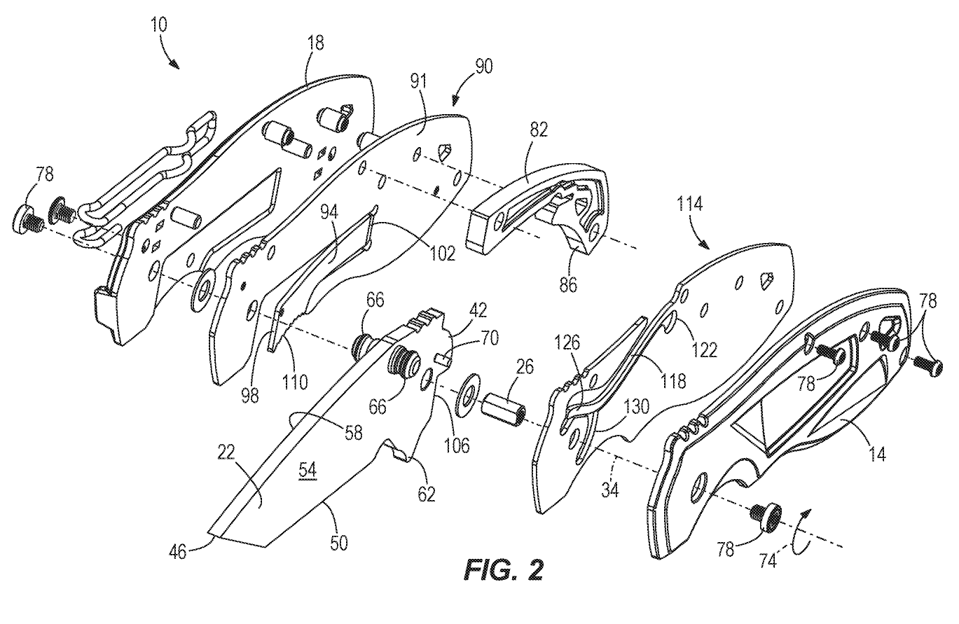

FIGS. 1 and 2 illustrate a knife, and more specifically, a folding knife 10. The knife 10 includes a first handle portion 14, a second handle portion 18, and a blade 22 pivotally coupled to the handle portions 14, 18. A pivot pin 26 couples the handle portions 14, 18 and the blade 22.

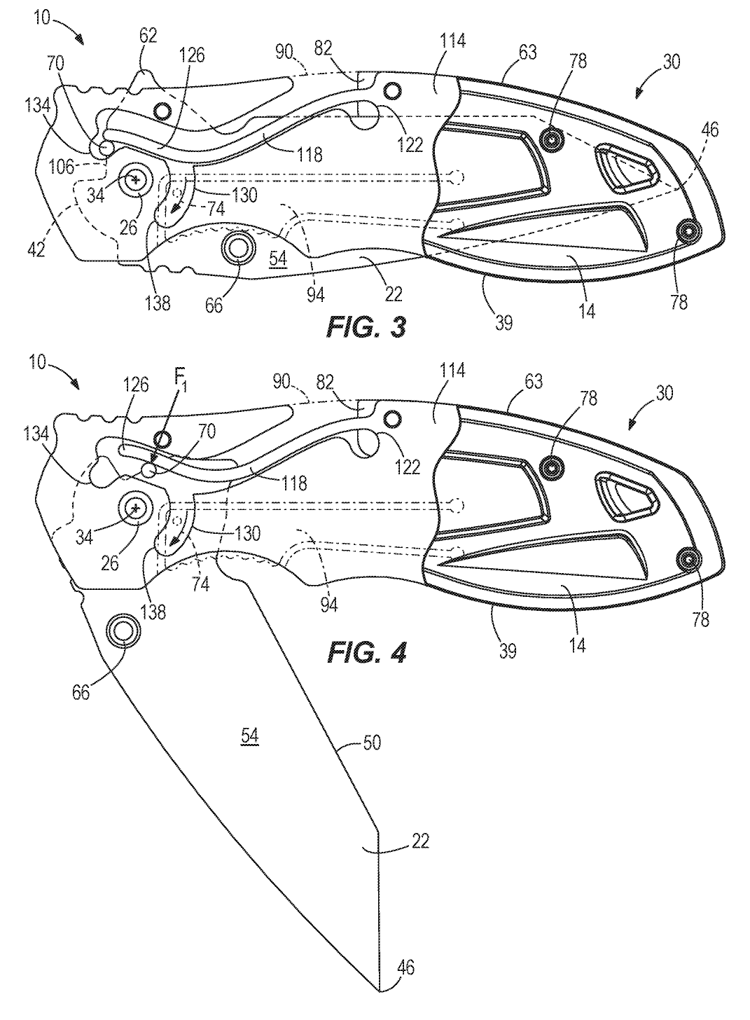

The handle portions 14, 18 each generally define half of a handle 30 of the knife 10. The blade 22 is pivotally coupled to the handle 30 via the pivot pin 26 so that the blade 22 can pivot about a pivot axis 34 between an extended position (FIG. 1) and retracted or closed position (FIG. 3). In the retracted position, a portion of the blade 22 is received and stored within the handle 30 between the portions 14, 18. The handle 30 includes a blade cavity 38 adjacent a front side 39 of the handle 38 that receives at least a portion of blade 22 in the retracted position. The blade cavity 38 is disposed between the handle portions 14, 18.

With continued reference to FIGS. 1 and 2, the blade 22 includes a tang 42 proximate the pivot axis 34 and a distal end 46 located opposite the tang 42. The blade 22 further includes a cutting edge 50 formed by opposing faces 54, 58 of the blade 22 converging toward each other to a common apex. The cutting edge 50 of the blade 22 is configured to be used by an operator to perform a cutting operation.

The blade 22 further includes a protruding portion (i.e., an actuator 62) proximate the tang 42. The actuator 62 is formed as an integral member of the blade 22 and protrudes outwardly from the tang 42. Specifically, the actuator 62 extends beyond the outer periphery 63 of the handle 30 in the extended and retracted position of the blade 22. As a result, an operator has access to the actuator 62 when the blade 22 is in any position. Although the actuator 62 of the illustrated embodiment is integrally formed with the blade 22, the actuator 62 may alternatively be a separate component from the blade 22 such that the blade 22 pivots in response to the actuator 62 acting on a portion of the blade 22, e.g. a kicker that is rotatable separate from the blade 22 and is configured to act on the blade 22 to open the blade 22.

The blade 22 further includes a thumb stud 66 and a post 70 (FIG. 3), both of which are secured to the blade 22 proximate the tang 42. Additionally, the thumb stud 66 and the post 70 extend away from the blade 22 in a perpendicular orientation with respect to one of the opposing faces 54, 58. The thumb stud 66 is positioned on the blade 22 such that the thumb stud 66 is located away from the outer periphery of the handle 30, whereas the post 70 is positioned on the blade 22 such that the post 70 is located on the interior of the handle 30. The actuator 62 and the thumb stud 66 are configured to be engaged by an operator to facilitate moving the blade 22, for example, in direction 74, or between the retracted position and the extended position.

With reference to FIG. 2, the knife 10 of the illustrated embodiment further includes a spacer 82, a locking liner 90, and a spring assist liner 114 disposed within the handle 30 of the knife 10. A plurality of fasteners 78 connects the spacer 82, the locking liner 90, the spring assist liner 114, and the handle portions 14, 18. The spacer 82 is disposed proximate the rear end of the knife 10 and interposed between the handle portions 14, 18. The spacer 82 defines a width (not shown) of the blade cavity 38. The spacer 82 includes a stop surface 86 that abuts the blade 22 in the retracted position of the blade 22 to inhibit further rotation of the blade 22 beyond the retracted position.

In the illustrated embodiment of FIG. 2, the locking liner 90 of the knife 10 is interposed between the blade 22 and one of the handle portions 18. The locking liner 90 maintains the blade 22 in the extended position. The locking liner 90 is formed as a unibody component having a planar main body 91, and a locking arm 94 (e.g., a leaf spring) with a free end 98 cantilevered away from a connecting end 102. The locking arm 94 is curved such that the free end 98 extends laterally outside of the plane of the locking liner 90. The locking arm 94 is movable between a locked configuration, in which the locking arm 94 inhibits movement of the blade 22, and an unlocked configuration, in which movement of the blade 22 is allowed. The locking arm 94 is biased toward the locked configuration, in which the free end 98 of the locking arm 94 engages a shoulder 106 of the tang 42 of the blade 22 to resist movement of the blade 22 away from the extended position. The free end 98 of the locking arm 94 includes a tab 110 that is at least partially disposed outside of the handle 30 to enable an operator to easily access the tab 110. The tab 110 facilitates moving the locking arm 94.

With continued reference to FIG. 2, the spring assist liner 114 is disposed adjacent to the face 54 of the blade 22 opposite of the locking liner 90. Specifically, the spring assist liner 114 is interposed between the blade 22 and the handle portion 14. The spring assist liner 114 is formed as a unibody component having a horizontally oriented cantilever spring portion 118 with a free end 126 and a fixed end 122. The distal end (e.g., the free end 126) of the cantilever spring portion 118 is opposite the fixed end 122. The distal end 126 engages (e.g., applies a force to) the post 70 of the blade 22 when the cantilever spring portion 118 is displaced from an unloaded configuration to a loaded configuration. Although the cantilever spring portion 118 is illustrated as being curvilinear between the fixed end 122 and the distal end 126, the cantilever spring portion 118 may alternatively be linear between the ends 122, 126.

The spring assist liner 114 further defines an arcuate slot 130 extending about the pivot axis 34. The arcuate slot 130 defines a path that partially intersects the cantilever spring portion 118. The post 70 of the blade 22 is received within and translates throughout the arcuate slot 130, such that the post 70 is capable of interacting with the cantilever spring portion 118. The arcuate slot 130 includes a first end 134 and a second end 138 opposite the first end 134. The post 70 of the blade 22 is proximate the first end 134 of the arcuate slot 130 when the blade 22 is in the retracted position and the post 70 is proximate the second end 138 when the blade 22 is in the extended position.

In operation, an operator grips the handle 30 of the knife 10 when the blade 22 is in the retracted position and the extended position. To pivot the blade 22 from the retracted position to the extended position, an operator applies a force to either the actuator 62 or the thumb stud 66, or both. To pivot the blade 22 from the extended position to the retracted position, an operator applies a force to either the actuator 62 or the thumb stud 66, or both, while simultaneously moving the locking arm 94 from the locked configuration to the unlocked configuration, as described in more detail below. As shown in the illustrated embodiment of the knife 10, the actuator 62 and the thumb stud 66 are easily accessible near the handle 30 of the knife 10, such that an operator can grip the handle 30 and simultaneously apply a force to actuate at least one of the actuator 62 and the thumb stud 66 with only one hand. However, an operator may alternatively grip the handle 30 of the knife 10 with one hand and apply a force to actuate the actuator 62 or the thumb stud 66, or both with the other hand.

With reference to FIG. 3, when the blade 22 is in the retracted position (e.g., the closed configuration), the blade 22 is biased towards the retracted position by the cantilever spring portion 118. Specifically, the distal end 126 of the cantilever spring portion 118 tends to maintain the post 70 proximate the first end 134 of the slot 130 and thus tends to maintain the blade 22 in the closed configuration. In order to pivot the blade 22 away from the retracted position, an operator applies a force to overcome the maintaining force of the cantilever spring portion 118 to allow the post 70 to slide past the distal end 126 of the cantilever spring portion 118. At this point, the post 70 is between the cantilever spring portion 118 and the pivot axis 34, as illustrated in FIG. 4. In one embodiment, the knife 10 may be configured such that a force greater than the maintaining force would be applied to at least one of the actuator 62 and the thumb stud 66 to allow the post 70 to overcome the maintaining force of the cantilever spring portion 118.

With reference to FIG. 4, when the blade 22 pivots from the retracted position toward the extended position, the post 70 of the blade 22 translates through the arcuate slot 130 in direction 74. Simultaneously, the free end 98 of the locking arm 94, which is in the unlocked configuration, slides against the opposing face 58 of blade 22 proximate the tang 42. Meanwhile, an operator continuously applies a force to at least one of the actuator 62 and the thumb stud 66 until the post 70 of the blade 22 reaches an equilibrium point spaced away from the first end 134 and the second end 138 of the slot 130. Past the equilibrium point, a force F1 is applied to the post 70 via the cantilever spring portion 118. The direction and magnitude of the force F1 is different than the maintaining force. For example, the force F1 is normal to the distal end 126 of the cantilever spring portion 118 such that the force F1 does not urge the post 70 toward the first end 134 or the second end 138 of the slot 130. Further, the magnitude of the force F1 is greater than the magnitude of the maintaining force because the cantilever spring portion 118 is displaced a greater distance away from the unloaded configuration. Accordingly, the cantilever spring portion 118 is in the loaded configuration.

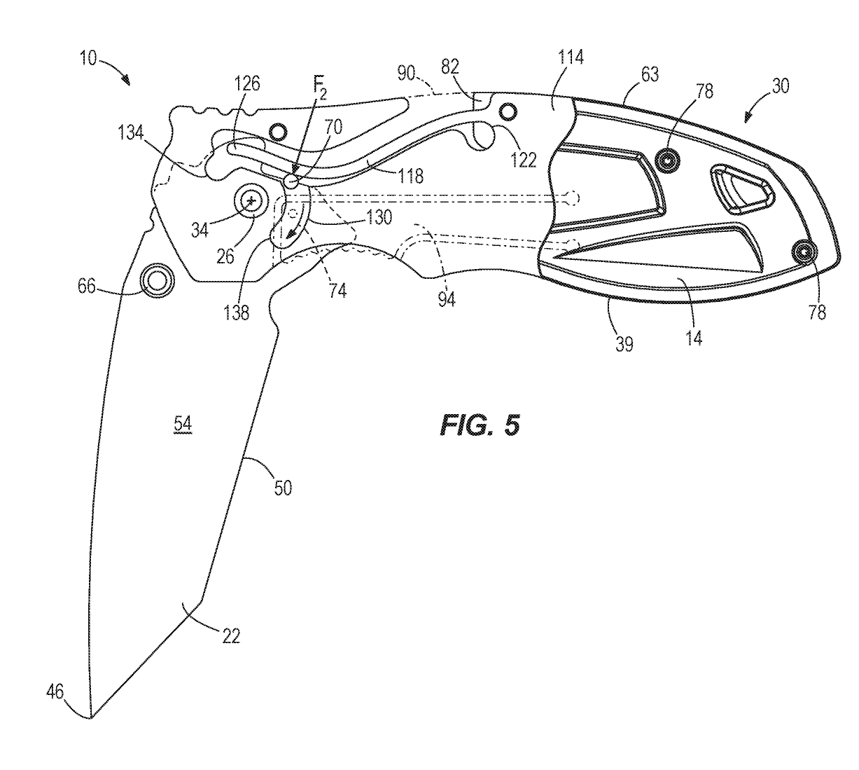

With reference to FIG. 5, the blade 22 is further moved toward the extended position, such that the post 70 of the blade 22 is between the equilibrium point and the second end 138 of the slot 130. At this point, the distal end 126 of the cantilever spring portion 118 applies a force F2 to the post 70 of the blade 22. As the post 70 moves beyond the equilibrium point in direction 74, the force F2 is not counteracted resulting in the blade 22 being assisted to pivot toward the extended position. As the blade 22 moves to the extended position, the post 70 moves towards the second end 138 of the slot 130, and the free end 98 of the lock arm 94 displaces laterally from the unlocked configuration to the locked configuration. As a result, the free end 98 engages the shoulder 106 of the tang 42 to avoid inadvertent movement of the blade 22 from the extended position.

In order to pivot the blade 22 from the extended position to the retracted position, the locking arm 94 is released from the locked configuration by laterally displacing (e.g., toward the handle portion 18) the free end 98 to be coplanar with the plane of the locking liner 90. The tab 110 of the locking arm 94 is engaged by an operator to move the free end 98. An operator applies a force greater than F2 in order to move the post 70 in the opposing direction of direction 74, thereby positioning the blade 22 at the equilibrium point. As the post 70 moves beyond the equilibrium point, the force F1 is not counteracted resulting in the blade 22 being assisted to pivot toward the retracted position. In response to the blade 22 moving to the retracted position, the post 70 is proximate the first end 134 of the slot 130.

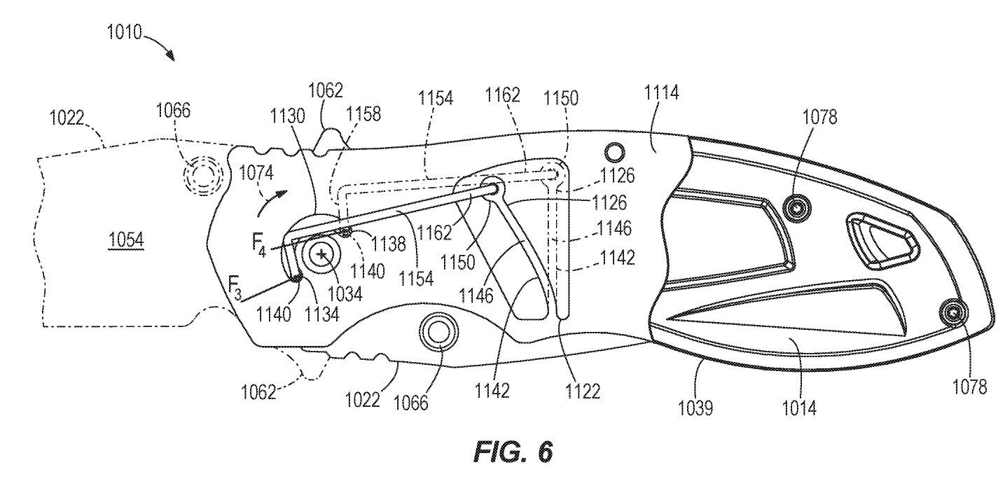

FIG. 6 illustrates a knife 1010 according to another embodiment. The knife includes a spring assist liner 1114 that includes a vertically oriented cantilever spring portion 1142 to bias a blade 1022 of the knife 1010 toward a retracted and an extended position. Further, the blade 1022 of the illustrated embodiment includes an aperture 1140 proximate a tang 1042 of the blade 1022 to provide a connection point between the blade 1022 and the cantilever spring portion 1142 of the liner 1114. The aperture 1140 of the blade 1022 follows the path defined by an arcuate slot 1130 of spring assist liner 1114 when the blade 1022 pivots between the extended position and the retracted position. The cantilever spring portion 1142 of the spring assist liner 1114 includes an elongated shaft portion 1146 with a fixed end 1122 and a free end 1126. The distal end (e.g., the free end 1126) of the cantilever spring portion 1142 is opposite the fixed end 1122, and includes an eyelet 1150 to provide another connection point between the blade 1022 and the cantilever spring portion 1142 of the liner 1114. A linkage 1154 is also provided having a first end 1158 passing through the aperture 1140 of the blade 1022 and coupling the blade 1022 to the linkage 1154, and a second end 1162 passing through the eyelet 1150 of the cantilever spring portion 1142 and coupling the linkage 1154 to the cantilever spring portion 1142. The linkage 1154 provides a rigid connection between the blade 1022 and the cantilever spring portion 1142 of the liner 1114, such that the distance between the eyelet 1150 and the aperture 1140 remains constant as the blade 1022 is moved between open and closed configurations. Alternatively, in another embodiment, the linkage 1154 may provide a flexible connection, such that the distance between the eyelet 1150 and the aperture 1140 may vary as the blade 1022 is moved between open and closed configurations.

In operation, the first end 1158 of the linkage 1154 translates between the first end 1134 and the second end 1138 of the arcuate slot 1130 in direction 1074 when the blade 1022 pivots between the retracted position (e.g., closed configuration) and the extended position (e.g., open configuration), respectively. As shown in FIG. 6, when the first end 1158 of the linkage 1154 is proximate the first end 1134 of the arcuate slot 1130 (i.e., the blade is in the closed configuration), the cantilever spring portion 1142 is in the loaded configuration. Accordingly, a force F3 is applied to the blade 1022 through the linkage 1154 to urge the blade 1022 toward the retracted position and to tend to maintain the blade 1022 in the closed configuration. As a result of the force F3 (e.g., the direction of the force F3), the first end 1158 of the linkage 1154 abuts the first end 1134 of the slot 1130 and the blade 1022 tends to be maintained in the closed configuration. In order to move the first end 1158 of the linkage 1150 away from the first end 1134 of the slot 1130, an operator applies a force (e.g., in one embodiment, a force greater than the force F1) to either the actuator 1062 or the thumb post 1066, or both. Eventually, the aperture 1140 moves toward an equilibrium point located between the first end 1134 and the second end 1138 of the slot, such that the blade 1022 is neither biased toward the extended nor the retracted positions. However, the cantilever spring portion 1142 is still in a loaded configuration. At this point, the direction of force exerted on the aperture 1140 extends along a virtual line that intersects the pivot axis 1034. Pivoting the blade 1022 to position the aperture 1140 beyond the equilibrium point (i.e., between the equilibrium point and the second end 1138 of the arcuate slot 1130) causes the first end 1158 of the linkage 1154 to apply a force F4 on the blade 1022 through the aperture 1140. Once the blade 1022 is beyond the equilibrium point (e.g., point at which an axis between the first end 1158 of the linkage 1154 and the center of the eyelet 1150 passes the center of the pivot axis 1034), the spring force of the cantilever spring portion 1142 (e.g., force F4) assists the blade 1022 in opening (e.g., tends to move the blade 1022 to the open configuration). Accordingly, the first end 1158 of the linkage 1154 is moved to the second end 1138 of the slot 1130. As this point, the cantilever spring portion 1142 is in the unloaded configuration, and the locking arm 1094 of the locking liner 1090 moves to the locked configuration to lock the blade 1022 in the extended position.

Although the invention has been described in detail with reference to certain preferred embodiments, variations and modifications exist within the scope and spirit of one of more independent aspects of the invention as described.

What is claimed is:

1. A folding knife comprising:
a handle;
a blade having a cutting edge, the blade is pivotably coupled to the handle, the blade is pivotable about a pivot axis relative to the handle between a retracted position and an extended position, the blade is received within the handle in the retracted position and the cutting edge is exposed in the extended position;
a liner between the handle and the blade, the liner has a resilient member that biases the blade toward the retracted position when the blade is in the retracted position and the resilient member biases the blade toward the extended position when the blade pivots in a direction from the retracted position toward the extended position.

2. The folding knife of claim 1, wherein the liner defines a plane and the resilient member moves within the plane.

3. The folding knife of claim 1, wherein the liner is a unibody component coupled to the handle.

4. The folding knife of claim 1, wherein the resilient member has a first end and a second end cantilevered away from the first end, the second end of the resilient member contacts at least a portion of the blade.

5. The folding knife of claim 1, wherein the liner defines an arcuate slot and the resilient member extends into the arcuate slot.

6. The folding knife of claim 5, further comprising a post coupled to the blade and oriented perpendicular with respect to the blade, the post translates through the arcuate slot of the liner as the blade moves between the retracted position and the extended position.

7. The folding knife of claim 6, wherein the resilient member contacts the post and biases the post when the blade is in the retracted position, and wherein the resilient member contacts the post and biases the post when the blade is pivoting toward the extended position.

8. The folding knife of claim 6, wherein the post is encased within the handle.

9. The folding knife of claim 1, further including a locking liner between the blade and the handle for maintaining the blade in the extended position, the locking liner is a unibody component coupled to the handle.

10. The folding knife of claim 9, wherein the locking liner includes a locking arm that is moveable between a locked configuration, in which the locking arm inhibits movement of the blade and an unlocked configuration, in which the blade is permitted to move.

11. The folding knife of claim 10, wherein the locking arm has a first end and a second end cantilevered away from the first end.

12. The folding knife of claim 11, wherein the locking liner defines a plane, wherein the second end of the locking arm lies within the plane of the locking liner when the blade is in the retracted position whereas the second end of the locking arm extends outside of the plane of the locking liner when the blade is in the extended position to interfere with the blade.

13. A folding knife comprising:
a first handle portion;
a second handle portion;
a blade having a cutting edge, the blade pivotably coupled to the first handle portion and the second handle portion about a pivot axis;
a first liner between the first handle portion and the blade, the first liner is a unibody component and has a resilient member to bias the blade toward a retracted position and an extended position, the cutting edge is between the first and second handle portions in the retracted position and the cutting edge is exposed in the extended position; and
a second liner between the second handle portion and the blade, the second liner is a unibody component and has a locking arm to maintain the blade in the extended position.

14. The folding knife of claim 13, wherein the first liner defines a first plane and the resilient member moves within the first plane.

15. The folding knife of claim 13, wherein the second liner defines a second plane and the locking arm moves transverse to the second plane.

16. The folding knife of claim 13, wherein the resilient member has a first end and a second end cantilevered away from the first end, the second end of the resilient member contacts at least a portion of the blade.

17. The folding knife of claim 13, wherein the first liner defines an arcuate slot and the resilient member extends into the arcuate slot.

18. The folding knife of claim 17, further comprising a post coupled to the blade and oriented perpendicular with respect to the blade, the post translates through the arcuate slot of the first liner as the blade moves between the retracted position and the extended position.

19. The folding knife of claim 18, wherein the resilient member contacts the post and biases the post when the blade is in the retracted position, and wherein the resilient member contacts the post and biases the post when the blade is pivoting toward the extended position.

20. The folding knife of claim 18, wherein the post is between the first handle portion and the second handle portion.
